(19) United States
(12) Patent Application Publication
(10) Pub. No.: US 2002/0196981 A1
(43) Pub. Date: Dec. 26, 2002

(54) Method and system for compressing image data

(76) Inventor: Kei Satoh, Atsugi-shi (JP)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/158,661

(22) Filed: May 30, 2002

(30) Foreign Application Priority Data
May 30, 2001 (JP) 2001-162686

(51) Int. Cl. G06K 9/46; G06K 9/36

(52) U.S. Cl. 382/239; 375/240.02

(57) ABSTRACT

An image processing system compresses image scanned data based upon a selected one of the predetermined unique compression techniques for internal processing. For external processing, the scanned image is compressed by a well-known or standard compression technique to facilitate the interface. In addition, the scanned image is arbitrarily scaled based upon a scaling factor for the internal and or external processing to provide further flexibility.

### FIELD OF THE INVENTION

The current invention is generally related to image processing, and more particularly related to a method of and a system for generating an image based upon compressed image data from an external image processing unit.

### BACKGROUND OF THE INVENTION

With respect to prior art technology in transferring compressed image data to an outside unit, Japanese Patent Publication Hei 5-075871 discloses image data that has been compressed by a widely used compression technique. For the sake of compatibility, a widely used compression technique is used rather than a unique compression technique. Although it is compressed, since the compressed data is decompressed to a voluminous amount of data at a destination, the compressed data is not tailored to the characteristics of the destination environment. It is also desirable to differentiate the compression technique based upon other circumstances. For example, a first circumstance requires that image data is internally compressed and that the compressed data is printed in the same environment. In the first circumstance, a unique compression technique can be used to optimize the cost and the high-speed efficiency since the image data is processed in the common environment. A second circum stance requires that image data is compressed and exported to another environment. In the second circumstance, a commonly known compression technique is more advantageous than a peculiar or unique technique between the source and the destination.

It remains desirable for a prior art compression technique and system to adjust the compression technique based upon the characteristics of a destination environment when the compression data is transferred to the known destination. Furthermore, the prior art compression technique also remains desirable to maintain the cost effectiveness and the efficiency when color image data is internally processed.

### SUMMARY OF THE INVENTION

In order to solve the above and other problems, according to a first aspect of the current invention, a method of compressing image data, including the steps of scanning an image to generate image data in an internal system; selecting a compression techniques from a set of predetermined compression techniques based upon the image data to generate compressed image data; scaling the compressed image data to scaled image data according to a first scaling factor; and exporting the scaled image data to an external system.

According to a second aspect of the current invention, a method of compressing image data, including the steps of scanning an image to generate image data in an internal system; selecting a compression techniques from a set of predetermined unique compression techniques based upon the image data to generate compressed image data; decompressing the compressed image data to generate decompressed image data; scaling the decompressed image data to scaled image data according to a scaling factor that is specified by an external system; compressing the scaled image data to further compressed image data by a predetermined widely used compression technique; and exporting the further compressed image data to the external system.

According to a third aspect of the current invention, a method of compressing image data, including the steps of: scanning an image to generate image data in a RGB data format in an internal system; compressing the image data based upon a predetermined unique compression techniques to generate compressed image data; storing the compressed image data in a memory storage area to have stored image data; in case of internal processing, reading the stored image data from the memory storage area; decompressing the stored image data to generate decompressed image data; converting the decompressed image data from the RGB format to a YMCK data format; in case of external processing, reading the stored image data from the memory storage area; compressing the stored image data to further compressed image data by a predetermined widely used compression technique; and exporting the further compressed image data to an external system.

According to a fourth aspect of the current invention, a system for compressing image data, including: an image input unit for scanning an image to generate image data in an internal system; a main control unit connected to the image input unit for selecting a compression techniques from a set of predetermined compression techniques based upon the image data; a compression unit connected to the main control unit and the image input unit for compressing the image data based upon the selected compression technique to generate compressed image data; a scaling unit connected to the compression unit for scaling the compressed image data to scaled image data according to a first scaling factor; and a host interface unit connected to the scaling unit for exporting the scaled image data to an external system.

According to a fifth aspect of the current invention, system for compressing image data, including: an input unit for scanning an image to generate image data in an internal system; a main control unit connected to the image input unit for selecting a compression techniques from a set of predetermined unique compression techniques based upon the image data; a compression unit connected to the main control unit and the image input unit for compressing the image data based upon the selected compression technique to generate compressed image data; a decompression unit connected to the compression unit for decompressing the compressed image data to generate decompressed image data; a scaling unit connected to the decompression unit and the compression unit for scaling the decompressed image data to scaled image data according to a scaling factor that is specified by an external system, the compression unit compressing the scaled image data to further compressed image data by a predetermined widely used compression technique; and a host interface unit connected to the scaling unit for exporting the further compressed image data to the external system.

According to a sixth aspect of the current invention, a system for compressing image data, including: an input unit for scanning an image to generate image data in a RGB data format in an internal system; a first compression unit connected to the image input unit for compressing the image data based upon a predetermined unique compression techniques to generate compressed image data; a memory unit connected to the first compression unit for storing the compressed image data to have stored image data; a decompression unit connected to the memory unit for reading the stored image data from the memory unit and decompressing the stored image data to generate decompressed image data; a color correction unit connected to the decompression unit and the memory unit for converting the decompressed image data from the RGB format to a YMCK data format in case of internal processing; a second compression unit connected to the memory unit for reading the stored image data from the memory unit and compressing the stored image data to further compressed image data by a predetermined widely used compression technique in case of external processing; and a external interface unit connected to the second compression unit for exporting the further compressed image data to an external system in case of the external processing.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram illustrating one preferred embodiment of the color image processing unit according to the current invention.

FIG. 2 is a block diagram further illustrating components of the preferred embodiment in the compression/decompression unit according to the current invention.

FIG. 3 is a block diagram further illustrating components of the preferred embodiment in the format conversion unit according to the current invention.

FIG. 4 is a flow chart illustrating steps involved in a preferred process of compressing image data according to the current invention.

### DETAILED DESCRIPTION OF THE PREFERRED EMBODIMENT(S)

Based upon incorporation by external reference, the current application incorporates all disclosures in the corresponding Japanese priority document (JP2001-162686, filed on May 30, 2001) from which the current application claims priority.

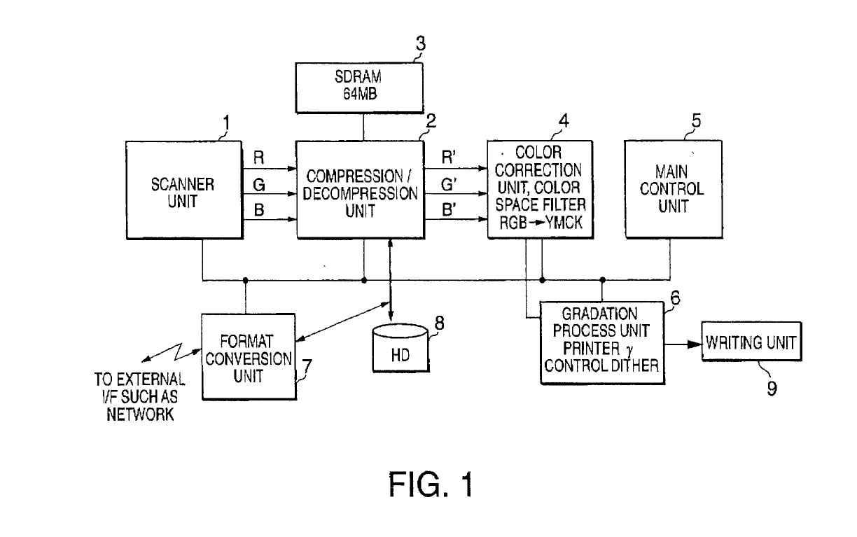

Referring now to the drawings, wherein like reference numerals designate corresponding structures throughout the views, and referring in particular to FIG. 1, a block diagram illustrates one preferred embodiment of the color image processing unit according to the current invention. In the preferred embodiment, a scanner unit 1 includes a charge couple device (CCD). The scanner unit processes signals from the CCD and outputs red, green and blue (RGB) signals to a compression/decompression unit 2. During the above processing, the scanner unit 1 detects the original input image sheet size. The compression/decompression unit 2 compresses the RGB signals from the scanner unit 1 and outputs to a memory unit 3 such as a synchronous dynamic random access memory (SDRAM) for storage. The compression/decompression unit 2 reads image data from the memory unit 3, decompresses it to R′G′B′ data and outputs the R′G′B′ data to a color correction unit 4. The color correction unit 4 performs a space filter process and a Yellow-Magenta-Cyan-blacK (YMCK) data conversion process on the R′G′B′ data.

Still referring to FIG. 1, the preferred embodiment of the color image processing unit according to the current invention further includes a main control unit 5, a gradation process unit 6, a format conversion unit 7, a hard disk unit 8 and a writing unit 9. After the gradation process unit 6 performs a printer γ correction process, a scalar process and a dithering process on the YMCK data from the color correction unit 4, the gradation process unit 6 transfers the above processed data to the writing unit 9. According to the transferred image data, the writing unit 9 optically writes on a photoreceptor surface for each of a predetermined set of colors, and an image is formed on the photoreceptor surface for each color. A transfer section in the writing unit 9 transfers the image on the photoreceptor onto a sheet of paper for each color, and a fixation section fixes the transferred image on the sheet for each color. Alternatively, the predetermined number of colors such as four colors is transferred at the same time onto the sheet and is subsequently fixed at the same time. Since the above transfer and fixation sections are generally prior art technology, the corresponding descriptions are not repeated here. Furthermore, in alternative to the above described optical writing for the electrophotography method, an image is formed by other prior art technologies such as ink jet technology. The format conversion unit 7 decompresses uniquely compress data from the compression/decompression unit 2 and converts to a predetermined widely used format after it is being scaled. The hard disk unit 8 is a secondary memory and further includes a magnetic memory medium or disk and a disk access mechanism. The hard disk unit 8 is used to store information that is temporarily stored in the memory unit 3. For example, during the sort and screen processes, the original image is stored in the hard disk from the memory unit 3 so that the stored image is later used.

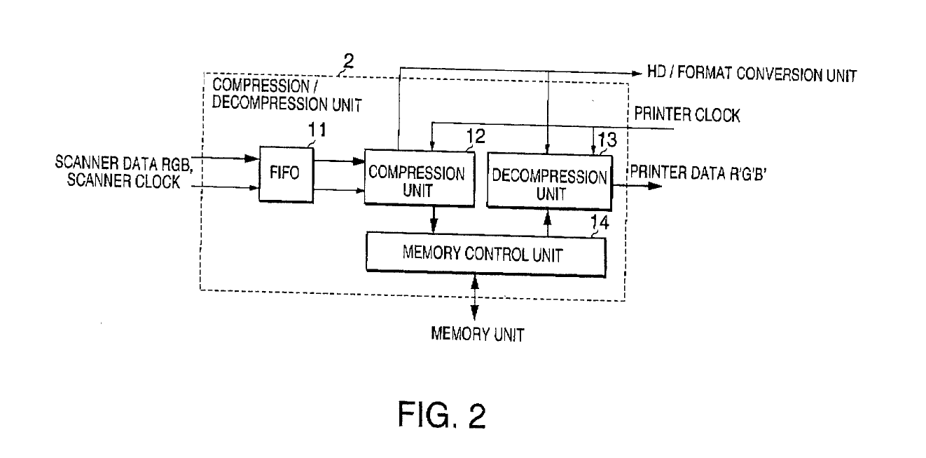

Now referring to FIG. 2, a block diagram further illustrates components of the preferred embodiment in the compression/decompression unit 2 according to the current invention. The compression/decompression unit 2 further includes a First-In-First-Out (FIFO) queue 11, a compression unit 12, a decompression unit 13 and a memory control unit 14. The compression/decompression unit 2 is set to the following three modes based upon a parameter value from the main control unit 5 as shown in FIG. 1. The three modes include 1) a fidelity generation color mode in which a compression rate is set without causing an effect on special image recognition; 2) a non-fidelity color mode in which the compression rate is raised; and 3) a single color mode in which a high-compression technique is used mainly for the G data.

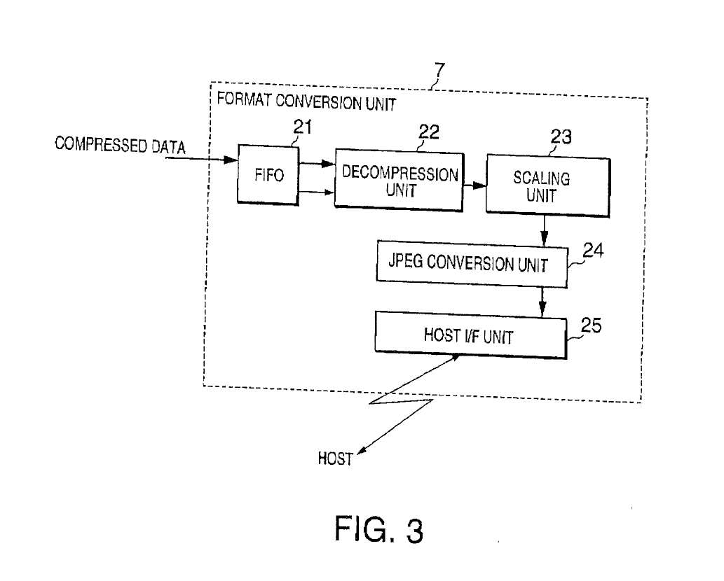

Now referring to FIG. 3, a block diagram further illustrates components of the preferred embodiment in the format conversion unit 7 according to the current invention. The format conversion unit 7 further includes a First-In-First-Out (FIFO) queue 21, a decompression unit 22, a scaling unit 23, a JPEG conversion unit 24 and a host interface (I/F) unit 25.

Referring to FIGS. 1, 2 and 3, a data flow will be described below. The image data is scanned in via the scanner 1. After the generated RGB image data is compressed at the compression unit 12 and is sent to the memory control unit 14 in the compression/decompression unit 2, the processed data is stored in the memory unit 3. The stored compressed data in the memory unit 3 is decompressed at the decompression unit 13 via the memory control unit 14 in the compression/decompression unit 2. As a result, the decompressed R′G′B′ data is outputted to the color correction unit 4. The scanner 1 scans image data once, and the compression/decompression unit 2 compresses the image data. The compressed image data is stored in the memory unit 3. The compressed data is later read from the memory unit 3 and is decompressed for a display. The decompressed image data is sent to the color correction unit 4. The color correction unit 4 converts the decompressed image data into YMCK data. According to a predetermined copy sequence, a corresponding color correction table is set from the main control unit 5 for each of the predetermined set of colors. For the YMCK data, the above process is repeated for four times for making a copy. By reading from the memory unit 3, the mechanical scanning motion is reduced to ¼.

The effect of the single scan is significant since there is no need for an original image to be subsequently scanned at the same position. For example, if a book is used as an original source containing images, the book needs to be held at the exact position to avoid discrepancy in position for different colors while the image is drawn on the photoreceptor drum for each of the four colors. Similarly, when the outputs or printouts are sorted, the compressed image data in the memory unit 3 is stored in the hard disk 8 that functions as a secondary compression unit and is connected to the compression/decompression unit 2. The compressed data from the hard disk 8 is read into the memory unit 3 depending upon the needs, and the compressed data in the memory unit 3 is reused as copy data. The above is so called electronic sort.

The compression/decompression unit 2 includes a plurality of compression units A through C and decompression units A through C. Depending upon a specified image quality mode, a compression process mode is selected. The compression unit 12 and the decompression unit 13 run unique compression and decompression techniques and each have the following three distinct functions. The compression unit 12 and the decompression unit 13 work for the Joint Photographic Experts Group (JPEG) compression and decompression, which is a standard color image compression technique. The compression unit 12 and the decompression unit 13 also work for character edges compression and decompression without losing image quality. Lastly, the compression unit 12 and the decompression unit 13 have a high compression rate for black and white images by focusing on the G data. One of the above three functions is selected depending upon the input image data characteristics so that a highly efficient process and highly efficient memory utilization are improved. For example, copiers have a text mode, a photographic mode, a text/photographic mode, a black-and-white mode and a color mode. Each mode is associated with a corresponding predetermined compression/decompression technique, and a particular mode is selected in the copier to optimize a compression method. In a single color mode, the compression rate is improved by adapting a compression technique that primarily utilizes the G data.

To transmit the data to a host, the compressed image data from the memory unit 3 is transferred to the format conversion unit 7 and is converted into a TIF format data based upon a widely used JPEG compression technique. By the above described conversion, the preferred embodiment according to the current invention enables to perform a unique and optimal compression and decompression technique that is internally selected while the preferred embodiment interfaces with an external system through a widely used compression and decompression technique. The preferred embodiment thus improves the compatibility with external systems. The image data amount is approximately 100 mega bytes at approximately 600 dpi in an A4 sheet for a 24-bit image. Although a compression rate of 1/20 makes the 100 mega-byte file into a relatively small file, the decompression brings the large 100 mega-byte file at the host site. The scale factor is adjusted according to a necessary detail or resolution level at the host side. The compressed and internally stored image data is used and arbitrarily scaled by the scaling unit 23 based upon a specified scale factor. The scaled image data is further converted into a predetermined widely used image data format. That is, depending upon the purpose of the image data, if approximately 100 dpi is a sufficient resolution level, since the file capacity load becomes 1/36 at the host side, the system throughput improves.

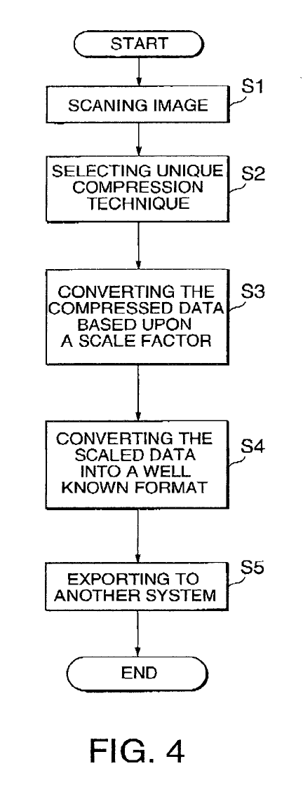

Now referring to FIG. 4, a flow chart illustrates steps involved in a preferred process of compressing image data according to the current invention. In a step S1, an image is scanned to generate digital image data. In a step S2, based upon a predetermined set of criteria, one compression technique is selected from a group of predetermined compression techniques. The selection criteria include a variety of conditions such as the nature of the digital image data. For example, if the digital image data represents an edge portion of an image, the compression technique is selected so that the edges are optimally represented after compression. The selected compression technique is optionally unique to the internal system where the compression takes place. After the generated image data is internally compressed by the selected compression technique in the step S2, the compressed image data is optionally stored and further processed. One example of the optional internal further processing includes the generation of printer data for a known printer. When the compressed image data is to be exported to an external or host system from the current system where the image has been scanned, the compressed image is scaled based upon a scaling factor that has been specified by the external system in a step S3. The compressed image data is thus scaled to a desired size which the external system requires in the step S3. Lastly, as described above, if the selected compression technique in the step S2 is unique, the current data format is also unique and unknown to the external system. To facilitate the process at the external system, the scaled image data undergoes a step S4 where the data format is converted from the current format to a widely accepted or standard format. The scaled compressed image data in the standard data format is now exported to the external system from the current system in a step S4. Alternatively, the image data is optionally further scaled for the second time based upon an additional scaling factor, which is independent of the original scaling factor.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of compressing image data, comprising the steps of:
scanning an image to generate image data in an internal system;
selecting a compression techniques from a set of predetermined compression techniques based upon the image data to generate compressed image data;
scaling the compressed image data to scaled image data according to a first scaling factor; and
exporting the scaled image data to an external system.

2. The method of compressing image data according to claim 1 further comprising additional steps of:
storing the compressed image data; and
further processing the compressed image data.

3. The method of compressing image data according to claim 2 wherein said further processing step includes processing the compressed image data to generate print image data.

4. The method of compressing image data according to claim 1 wherein the first scaling factor is specified by the external system.

5. The method of compressing image data according to claim 1 wherein the first scaling factor is specified by the internal system.

6. The method of compressing image data according to claim 1 further comprising an additional step of converting the scaled image data from a predetermined data format to a well-known data format before said exporting step.

7. The method of compressing image data according to claim 1 further comprising an additional step of converting the scaled image data from a predetermined data format to a data format that is used by the external system before said exporting step.

8. The method of compressing image data according to claim 1 further comprising an additional step of decompressing the compressed image data prior to said scaling step.

9. The method of compressing image data according to claim 8 further comprising additional steps of:
storing the scaled image data; and
further processing the scaled image data.

10. The method of compressing image data according to claim 9 further comprising an additional step of further scaling the scaled image data based upon a second scaling factor.

11. The method of compressing image data according to claim 1 wherein the second scaling factor is specified by the external system.

12. A method of compressing image data, comprising the steps of:
scanning an image to generate image data in an internal system;
selecting a compression techniques from a set of predetermined unique compression techniques based upon the image data to generate compressed image data;
decompressing the compressed image data to generate decompressed image data;
scaling the decompressed image data to scaled image data according to a scaling factor that is specified by an external system;
compressing the scaled image data to further compressed image data by a predetermined widely used compression technique; and
exporting the further compressed image data to the external system.

13. A method of compressing image data, comprising the steps of:
scanning an image to generate image data in a RGB data format in an internal system;
compressing the image data based upon a predetermined unique compression techniques to generate compressed image data;
storing the compressed image data in a memory storage area to have stored image data;
in case of internal processing,
reading the stored image data from the memory storage area;
decompressing the stored image data to generate decompressed image data;
converting the decompressed image data from the RGB format to a YMCK data format;
in case of external processing,
reading the stored image data from the memory storage area;
compressing the stored image data to further compressed image data by a predetermined widely used compression technique; and
exporting the further compressed image data to an external system.

14. The method of compressing image data according to claim 13 further comprising an additional step of scaling the decompressed image data to scaled image data according to a scaling factor that is specified by the external system.

15. The method of compressing image data according to claim 13 further comprising an additional step of forming an image on an image recording medium according to the image data in the YMCK data format.

16. A system for compressing image data, comprising:
an image input unit for scanning an image to generate image data in an internal system;
a main control unit connected to said image input unit for selecting a compression techniques from a set of predetermined compression techniques based upon the image data;
a compression unit connected to said main control unit and said image input unit for compressing the image data based upon the selected compression technique to generate compressed image data;
a scaling unit connected to said compression unit for scaling the compressed image data to scaled image data according to a first scaling factor; and
a host interface unit connected to said scaling unit for exporting the scaled image data to an external system.

17. The system for compressing image data according to claim 17 further comprising:
a memory storage unit connected to said compression unit for storing the compressed image data; and
a color correction unit connected to said memory unit and said compression unit for further processing the compressed image data.

18. The system for compressing image data according to claim 17 wherein said color correction unit further processes the compressed image data to generate print image data.

19. The system for compressing image data according to claim 16 wherein the first scaling factor is specified by the external system.

20. The system for compressing image data according to claim 16 wherein the first scaling factor is specified by the internal system.

21. The system for compressing image data according to claim 16 further comprising a conversion unit connected to said scaling unit for converting the scaled image data from a predetermined data format to a well-known data format before sending the scaled image data to said host interface unit.

22. The system for compressing image data according to claim 16 further comprising a conversion unit connected to said scaling unit for converting the scaled image data from a predetermined data format to a data format that is used by the external system before sending the scaled image data to said host interface unit.

23. The system for compressing image data according to claim 16 further comprising a decompression unit connected to said scaling unit for decompressing the compressed image data to generate decompressed image data, wherein said scaling unit scaling the decompressed image data to the scaled image data.

24. The system for compressing image data according to claim 23 further comprising:
a storing unit for storing the scaled image data; and
a processing unit connected to said storing unit further processing the scaled image data.

25. The system for compressing image data according to claim 24 wherein said scaling unit further scales the scaled image data based upon a second scaling factor.

26. The system for compressing image data according to claim 25 wherein the second scaling factor is specified by the external system.

27. A system for compressing image data, comprising:
an input unit for scanning an image to generate image data in an internal system;
a main control unit connected to said image input unit for selecting a compression techniques from a set of predetermined unique compression techniques based upon the image data;
a compression unit connected to said main control unit and said image input unit for compressing the image data based upon the selected compression technique to generate compressed image data;
a decompression unit connected to said compression unit for decompressing the compressed image data to generate decompressed image data;
a scaling unit connected to said decompression unit and said compression unit for scaling the decompressed image data to scaled image data according to a scaling factor that is specified by an external system, said compression unit compressing the scaled image data to further compressed image data by a predetermined widely used compression technique; and
a host interface unit connected to said scaling unit for exporting the further compressed image data to the external system.

28. A system for compressing image data, comprising:
an input unit for scanning an image to generate image data in a RGB data format in an internal system;
a first compression unit connected to said image input unit for compressing the image data based upon a predetermined unique compression techniques to generate compressed image data;
a memory unit connected to said first compression unit for storing the compressed image data to have stored image data;
a decompression unit connected to said memory unit for reading the stored image data from said memory unit and decompressing the stored image data to generate decompressed image data;
a color correction unit connected to said decompression unit and said memory unit for converting the decompressed image data from the RGB format to a YMCK data format in case of internal processing;
a second compression unit connected to said memory unit for reading the stored image data from said memory unit and compressing the stored image data to further compressed image data by a predetermined widely used compression technique in case of external processing; and
a external interface unit connected to said second compression unit for exporting the further compressed image data to an external system in case of the external processing.

29. The system for compressing image data according to claim 28 further comprising a scaling unit connected to said decompression unit for scaling the decompressed image data to scaled image data according to a scaling factor that is specified by the external system.

30. The system for compressing image data according to claim 28 further comprising a printer unit connected to said color correction unit for forming an image on an image recording medium according to the image data in the YMCK data format.
